(19) United States
(12) Patent Application Publication
(10) Pub. No.: US 2005/0192025 A1
(43) Pub. Date: Sep. 1, 2005

(54) Method and apparatus for an interactive tour-guide system

(76) Inventor: Richard D. Kaplan, New York, NY (US)

Correspondence Address: ALLAN J. JACOBSON, 13310 Summit Square Center, Route 413 & Doublewoods Road, Langhorne, PA, 19047, US

(21) Appl. No.: 10/973,948

(22) Filed: Oct. 26, 2004

Related U.S. Application Data
(63) Continuation-in-part of application No. 10/111,248, filed on Apr. 22, 2002, now abandoned.

(51) Int. Cl. H04Q 7/20

(52) U.S. Cl. 455/456.1; 455/414.1

(57) ABSTRACT

An interactive tour guide system includes software downloaded from a tour-guide web site to a PDA (portable digital assistant) or tablet laptop computer. The user indicates his geographic location to the interactive tour-guide device by entry on a dynamic city map. Intelligent agent software responsive to a request from the user creates a customized tour program. The intelligent agent guides the user along the customized tour route by voice, video and/or graphics, and provides information about each exhibit on the tour. The downloaded interactive tour guide system provides interactive guided tours, theme guided tours and a self-guided “wander mode” tour. The virtual tour-guide system can personalize each directed tour by taking individual user expressed preferences into account, and can use collaborative filtering of experiences with prior users to suggest other exhibits which may be of interest to the present user. The interactive tour-guide system responds like a human tour-guide to the needs of the user.

### CROSS TO REFERENCE RELATED APPLICATIONS

This application is a continuation part application of my co-pending patent application Ser. No. 10/111,248, filed Apr. 22, 2002 and Ser. No. of 60/161646, filed Oct. 27, 1999.

### FIELD OF THE INVENTION

The present invention relates to tour-guide systems.

### BACKGROUND OF THE INVENTION

Tour-guide systems are known. In the simplest form, a self-guided tour system may include signposts and marked walking paths. The user follows the marks that indicate the route to each exhibit and reads the signs or displays that provide information about the historical and cultural significance of each exhibit. Outdoor self guided tour systems may include walking paths formed by dots or lines of bricks imbedded in the sidewalks, or markers on trees and buildings, which lead users to points of interest. Exhibits, as used herein, can mean anything of interest to a user, ranging from a building, a machine, a work of art or an artifact, to a living thing, or just a site having historical, cultural, entertainment or educational significance.

Some exhibits, in addition to displays containing text and graphics, are known to include audio programming devices that provide speech, music and sound effects relating to the exhibit. In well-known museum systems, the user approaches the exhibit and initiates the audio programming by pressing a button. Other tour-guide systems include short-range radio transmitters that broadcast audio programming to specially adapted receivers carried by the user. In the latter wireless system, as the user approaches each exhibit, the radio receiver carried by the user (which typically includes an earphone or headset for privacy) begins to receive the broadcast related to that exhibit.

Self-guided tours with portable information devices are known. For example, art museum systems have been known to include a portable device that plays audio information about each exhibit. The user enters the number of the exhibit into the portable player, which responds by playing pre-recorded information regarding the exhibit. Such systems typically store the recorded information in a programmed memory chip.

Guided tours by audio tape recorder are also known. The user inserts the tape (or other recording medium) into the player, and follows the instructions given. The user receives information about each exhibit, and directions to find the next exhibit on the tour. The tour-guide tape may include sound effects and music in addition to spoken material to effectively recreate historical-context or information of interest relating to each exhibit.

More recently, self-guided tour systems using the Global Positioning Satellite (GPS) system have been proposed. U.S. Pat. No. 5,767,795 to Shaphorst shows an electronic tour-guide system using a GPS receiver and a local data storage device, such as a CD-ROM. The GPS receiver determines the instantaneous geographic location, and the CD ROM player provides audio or video information on the history, geography, and culture associated with the geographic region including comments about a specific point of interest.

### SUMMARY OF THE INVENTION

The present invention is embodied in an interactive tour guide system downloaded from a tour-guide web site to a PDA (portable digital assistant) or tablet laptop computer. The user indicates his geographic location to the interactive tour-guide device. Intelligent agent software, responsive to a request from the user creates a customized tour program. The intelligent agent guides the user along the customized tour route by voice, video and/or graphics, and provides information about each exhibit on the tour. The interactive tour-guide system responds like a human tour-guide to the needs of the user.

The downloaded interactive tour guide system provides a dynamic city map with interactive guided tours, theme guided tours and a self-guided “wander mode” tour. The dynamic city map is also an interactive map that provides for a variety of overlaid information such as transit lines, restaurant locations, and hotel accommodations and the like.

The present invention is also embodied in a wireless virtual tour-guide device and system enabled to access a global communication network, such as the Internet. The tour-guide system is further embodied in a portable wireless device such as a cellular telephone or laptop computer with a cellular modem enabled to access a virtual tour-guide web site on the World Wide Web (WWW). The virtual tour-guide web site is designed as a portal for the global tourism community to access the Internet.

The geographic location of the wireless tour-guide device is reported to the virtual tour-guide web site. A customized tour program, such as a historical, cultural or entertainment tour is created and made available to the user by an intelligent agent software module that then guides the user along the selected tour route.

The present virtual tour-guide system may provide a directed tour and can personalize or customize the guided tour by taking the user's individual expressed preferences into account. An intelligent agent software module, using request/response software with voice recognition and text to speech conversion, makes the present invented tour-guide system a goal directed and interactive virtual tour-guide. The virtual tour-guide of the present invention is thus more like a human tour-guide than are any of the self-directed or fixed program tour-guide systems of the prior art.

### BRIEF DESCRIPTION OF THE DRAWINGS

FIG. 1 is a block diagram of a first embodiment of a web enabled wireless tour-guide system in accordance with the present invention.

FIG. 2 is a flow chart diagram illustrating the operation of the wireless tour-guide system of FIG. 1.

FIG. 3 is a block diagram of a second embodiment of a web enabled wireless tour-guide system in accordance with the present invention.

FIG. 4 is flow chart diagram illustrating the operation of the system of the virtual tour-guide web site of FIG. 3.

FIG. 5A is a diagram of the data format of an exhibit, which is part of a downloaded local tour database.

FIG. 5B is a diagram of the data structure illustrating an inventory of tours.

FIG. 6A is a block diagram of a third embodiment of an interactive tour-guide system in accordance with the present invention.

FIG. 6B is a flow chart diagram illustrating the operation of the virtual tour guide of the system of FIG. 6A

FIG. 7 is an overview of a dynamic city map in accordance with the present invention.

FIG. 8 is a screenshot of a dynamic city map in accordance with the present invention.

FIG. 9 is a screenshot of a dynamic city map illustrating interactive guided tours in accordance with the present invention.

FIG. 10 is a screenshot of a dynamic city map illustrating interactive guided tours in a wander mode in accordance with the present invention.

FIG. 11 is a screenshot of a dynamic city map illustrating interactive guided tours having an architecture theme in accordance with the present invention.

FIG. 12 is a screenshot of a dynamic city map of illustrating interactive guided tours having a historical theme in accordance with the present invention.

FIG. 13 is a screenshot of a dynamic city map illustrating interactive guided tours having an “arts and culture” theme in accordance with the present invention.

FIG. 14 is a screenshot of a dynamic city map illustrating interactive guided tours having an “urban life” theme in accordance with the present invention.

FIG. 15 is a screenshot of a dynamic city map illustrating transportation line overlays on a dynamic city map in accordance with the present invention.

### DETAILED DESCRIPTION

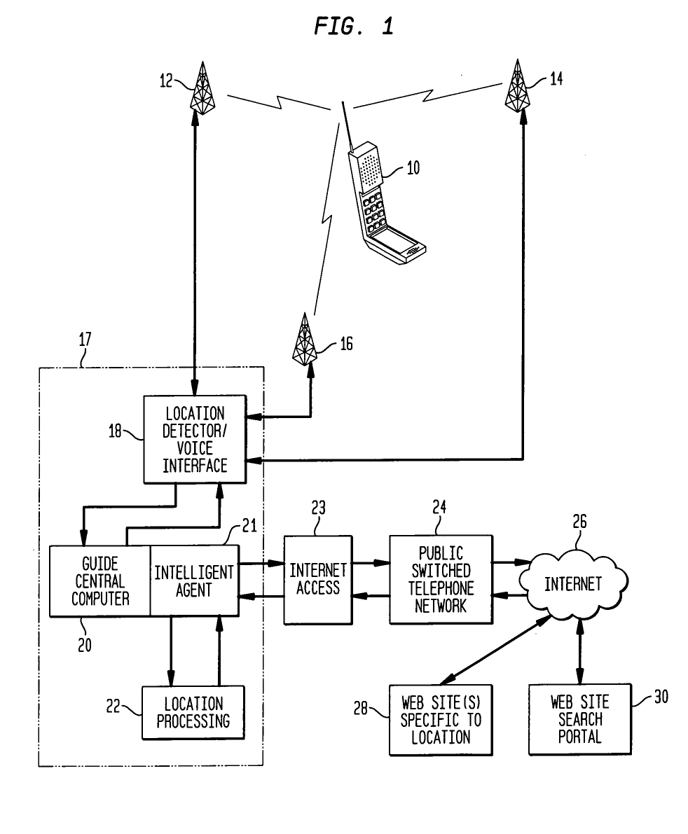

A wireless virtual tour-guide system in combination with a cellular telephone system is shown in FIG. 1. As described herein, a “user” can be a tourist, traveler, visitor, sightseer, vacationer, employee traveling on business, or any person or group of persons taking a trip with visits to places of interest for business, pleasure or instruction. The cellular telephone system in FIG. 1 includes a plurality of communication towers 12, 14, 16 within range of a wireless cellular handset 10. The cellular central station 17 comprises a location detector/voice interface 18, location processing 22, and a guide central computer 20 with intelligent agent software 21. The tour-guide system further includes Internet access capability 23 through the public switched telephone network 24 to reach web sites 28, 30.

The cellular central station 17 has the capability to determine the geographic location of the handset 10, as well as the identity of the user (by using caller ID features, for example). The raw data representing location of the handset may be determined using either relative time of arrival of the signal from handset 10 at the multiple communication towers 12, 14, 16, or by signal sensing directional receiving antennas, or any other means. The raw location data (time of arrival, direction and the like) is converted to useful form by location processing 22. The raw location data is converted to universal coordinates (latitude, longitude and altitude). If necessary, the location data is further converted to human recognizable form, such as names, street addresses and familiar landmarks. Cell phones also include cameras, clocks and secure credit information (for purchases) that can be useful for tourist.

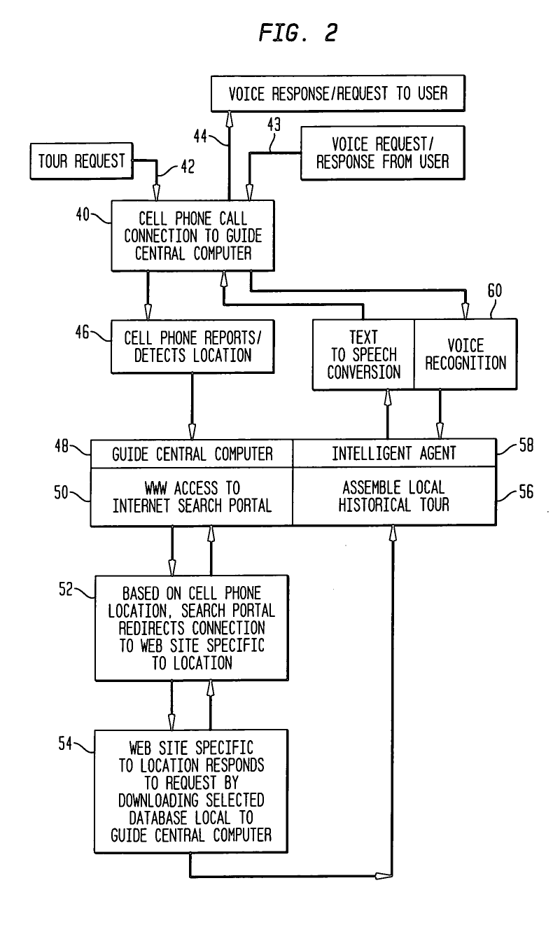

The flow chart of FIG. 2 illustrates the operation of the system of FIG. 1. In operation, a user initiates 40 a cellular phone call to the guide central computer. The user then enters, at the handset, a request 42 for a guided tour. The request 42 can be a natural voice request or a push button request on the keypad of the cellular phone handset. The cellular phone also reports data relating to the location of the handset to the cellular central station at step 46.

At the cellular central station (17 in FIG. 1), the intelligent agent software within the guide central computer 48 may initiate access to the World Wide Web on the Internet at step 50. Location processing (22 in FIG. 1) determines the universal coordinates and/or the geographic location of the handset, and forwards the handset location to the intelligent agent software. In response, the intelligent agent software accesses a specialized web search portal at step 50.

Based on determined location for the user's handset, the web search portal redirects 52 the intelligent agent software to connect to a web site (or to plural web sites) specific to the cellular phone location and/or user requests at step 54.

In particular, the specialized search portal (30 in FIG. 1) finds those web sites relevant to the user's location or user's requests by searching the database of tour-guide web sites at the web site search portal 30. The database of tour-guide web sites may be obtained by prior registration by individual web site(s) (28 in FIG. 1) at web site search portal (30 in FIG. 1), or from specially aggregated tour site information. For many user locales there may be only one relevant web site. However, in other locales, such as large urban centers, there may be several relevant web sites. The search results that are provided 52 by the web site search portal permit the guide central computer 48 and intelligent agent 58 to connect 50 to one or more of the URLs 54 most appropriate to the handset location.

Intelligent Agent Tour-Guide

Using the web site specific to the location of the handset as an information source, the intelligent agent software downloads 54 selected local tour-guide information to the guide central computer. Tour-guide information may include names and locations of local exhibits, along with text, graphics and audio related to such local exhibits. The intelligent agent software assembles or constructs one or more suggested guided tours for the user at step 56. As an alternative to creating a tour from scratch (a fully customized tour), the intelligent agent software may select from an inventory of canned tours, or modify a canned tour to create a new semi-customized tour. The intelligent agent asks the user, for example, “What kinds of places would you like to visit?” Or “would you like me to guide you on a tour of historical sites in the city?”

In its simplest form, the suggested tour is a fixed itinerary. The intelligent agent 58, via the voice interface text to speech conversion 60, instructs the user by voice response 44 to proceed to the nearest exhibit on the fixed tour. When the location detector indicates that the user is near the first exhibit, prepared information about the first exhibit is played (or offered to be played). If the information is of a preliminary nature and there is more information available about the exhibit, the intelligent agent may ask 44, “Would you like to know more?” The user may respond 43 by speaking a voice response into the microphone on the handset. The voice recognition interface (18 in FIG. 1) translates received speech response into a digital representation at step 60 for input to the intelligent agent 58 (21 in FIG. 1).

Depending on the user's response, the intelligent agent provides more detailed information regarding the first exhibit. Then the intelligent agent directs the user to the next (typically nearest) exhibit on the tour. If the user responded “no” to the last request above, the intelligent agent might ask, “Would you like to continue to the next destination?” If “yes”, the intelligent agent presents directions to the next exhibit on the fixed tour, and so forth. In the preferred embodiment, the intelligent agent uses speech to provide directions, however the intelligent agent may provide directions to an exhibit using text and/or graphics as well.

The user can cut short a description in progress of the current exhibit by an expression indicating no further interest in the current exhibit. In such case, the intelligent agent may suggest moving on to the exhibit on the tour. As indicated below in the discussion of revenue models and advertising, the intelligent agent may also direct the user to restaurants, lodging, stores, movies, shows, souvenir shops, beauty parlors, drug stores, gift shops and the like along the tour route. The intelligent agent may also provide topological information or describe other natural features along the tour route.

The user can customize the tour in progress (as well as the initial tour) by expressing special interests and indicating areas of interest and non-interest (examples of user preferences). The universe of requests and responses for users in a given locale is anticipated and programmed into the intelligent agent software. Collaborative filtering may be used to suggest other exhibits that previous users visited that might be of interest to the user. In such manner, the intelligent agent “learns” from the requests and responses of all visitors, so that the virtual tour-guide becomes more knowledgeable with experience. Furthermore, the intelligent agent “learns” from past experience with the preferences of a particular user as to which types of exhibits that most interest that particular user.

Tour-Guide Data Format: Exhibits

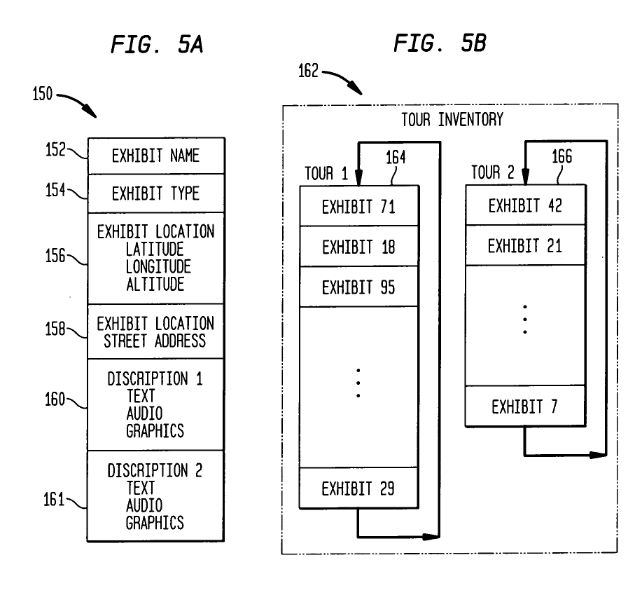

The data format for each exhibit in the downloaded local tour database is shown in FIG. 5A. A data record 150 which includes an exhibit name 152, exhibit type 154 and exhibit location 156, 158 represents each exhibit in the locale visited by the user. Exhibit type 154 is a numeric representation characterizing the type of exhibit (i.e., art museum, historic landmark, souvenir shop, topological feature, etc.).

Exhibit location is recorded in universal coordinate form (latitude, longitude and altitude) 156, human readable form (address and street name) 158 or by other methods of indicating location. The data record 150 may also include exhibit location recorded in raw data form to simplify location processing elsewhere in the system. That is, if the exhibit location is available in raw data form, location processing (22 in FIG. 1) to determine universal coordinates and/or street names may be simplified or eliminated. To the user, exhibit location in human understandable form is a meaningful response to the common traveler inquiry, “Where am I?”

In addition to the point location of an exhibit, the exhibit location field 156 contains a region or area location in which the user may view the exhibit. For example, a mural on the outside of a building may only be viewed while the user is standing in a region outside the building near the mural. At the same site, a painting inside the same building may only be viewed while the user is standing in a region near the painting inside the building. For this reason, the exhibit location field 156 also includes the viewing region for each exhibit in addition to the center point location.

The data record for each exhibit further contains an approximate estimate of time spent (dwell time) at that exhibit by a typical user. The typical dwell time information is used together with the typical travel time between exhibits to calculate an estimated total tour time. The experience of prior users is collected in a collaborative filtering process to estimate such typical dwell times and travel times.

The exhibit data record 150 contains one or more descriptive texts with accompanying audio and graphics 160, 161 related to the exhibit. For a simple exhibit, there may be a single description 160. For a more complex exhibit, there may typically be an introductory description 160 that is followed by one or more additional detailed descriptions 161, which are linked together in a logical order and called up as needed based on requests from the user for further information.

Tour-Guide Data Format: Tour Format

A tour consists of an ordered list of exhibits. A tour can be a prearranged list of exhibits, i.e., a fixed itinerary referred to as a “canned tour.” A tour can also be assembled by the intelligent agent tour-guide software, which creates the ordered list based on expressed preferences of the user. The downloaded database typically may include a collection of “canned” tours. For example, there may be a “one hour art museum tour”, a “three hour battlefield tour”, an “all day tour of the city landmarks,” and the like.

FIG. 5B illustrates examples of a tour inventory 162 of canned tours 164, 166. A first tour 164 includes exhibit 71, followed by exhibit 18, then exhibit 95 continuing along the tour to exhibit 29. Typically, a tour is a closed path ending where it began. Thus, exhibit 29 may be near to exhibit 71. In such manner, the tour may be started at any exhibit and continued in either direction through all the remaining exhibits. A second tour 166 includes exhibit 42, followed by exhibit 21 continuing through the tour to exhibit 7. The second tour 166 has fewer exhibits as compared to the first tour 164, and is generally a shorter tour. However, beyond the number of exhibits, the length of a tour is related to the amount of time spent at each exhibit, the amount of information requested from the intelligent agent, the intelligent agent responses and the time required to move from one exhibit to the next. Each of the canned tours 164, 166 may include a stored representation of the estimated total time required for each such tour.

An initial task of the intelligent agent virtual tour-guide is to match one of the canned tours 164, 166 to the preferences of the user. In addition, the intelligent agent virtual tour-guide selects a beginning point for the selected tour, typically at the exhibit closest to current location of the user.

If none of the canned tours 164, 166 is suitable to match the preferences of the user, the intelligent agent virtual tour-guide may construct an original tour from the exhibit records (150 in FIG. 5A) in the downloaded local database. For example, to suit a user's preferences, a tour can be specifically selected from a variety of exhibit types in which the user expressed an interest.

As another example, if the user indicates that only a short amount of time is available for a tour, the intelligent agent software selects fewer exhibits, and/or selects exhibits that are closer together. One way to create a short tour is to remove exhibits from a longer canned tour so that the total time required for the modified canned tour matches the time available to the user. In the alternative, the intelligent agent software may ask the user to indicate preferences and priorities of each exhibit in a long tour, in order to allocate the available time for a short tour. The tour exhibits may also be reordered according to the priority of expressed user preferences rather than the shortest route.

Alternate Embodiments

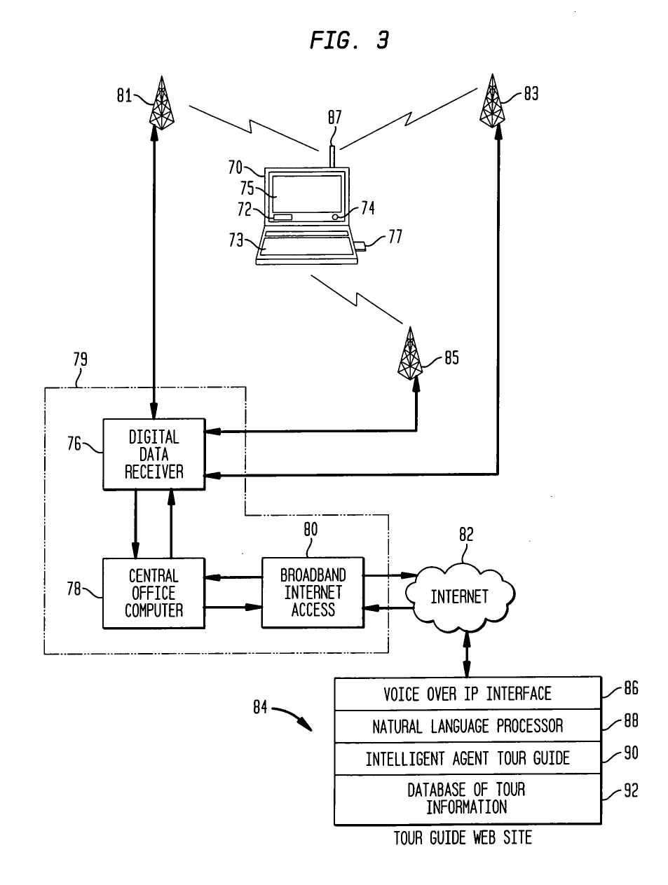

A wireless virtual tour-guide system is embodied in combination with a wireless data system as shown in the alternate embodiment of FIG. 3. A portable computer 70, or other mobile device, for use in the wireless data system, has a screen display 75, a keyboard 73, a microphone 74, a speaker 72 and a two-way digital data radio 87. The portable computer 70 further includes a GPS receiver module 77 or other method for determining the geographic location of the user. GPS receiver module 77 may be either a plug in PCMCIA peripheral as shown, or alternatively be built into the portable computer 70. Any type of portable computer or mobile device may be used, such as a laptop, a palmtop or a personal digital assistant (PDA). Since the preferred human interface in the present system is via natural voice request and voice response processing, and portability is very attractive to a typical user, a small pocket device with minimal screen functions is desirable.

An alternative embodiment to either a GPS location module or antenna triangulation is to present a map to the user on the display and have the user request or indicate his location on the map. Such feature would permit the user to receive a tour in any locale without a GPS receiver or triangulation system, so long as the user provides periodic location updates to the intelligent agent. The self-location feature would also permit the user to take a web based virtual tour in any country or city by indicating a desired location on a corresponding map. Such trial virtual tour using a web enabled virtual tour-guide permits the traveler to explore the exhibits at a destination before actual arrival. Virtual tours are available from any user location by visiting the virtual tour-guide web site (84 in FIG. 3) on the Internet. The user may enter his actual or virtual location by voice, graphics or keyboard.

There are two types of location information of significance in the present invented web enabled wireless tour-guide system. First, the user specifies a general first location for the tour. The tour guide web site then constructs a tour of exhibits in the vicinity of the supplied first location. Second, while on the tour, the user supplies second location information as to the user's location on the tour. The tour guide web site provides descriptions of the individual exhibit based on when the user is near an exhibit. For a virtual tour, the second location(s) are not real. For an actual tour, the second location(s) are the actual physical location(s) of the user. In either type of guided tour, the first location may be either virtual or actual. A user may request a tour either before or after arrival at the desired destination.

The wireless data system of FIG. 3 further comprises a plurality of communication towers 81, 83, 85 within range of the portable computer 70. The air interface between the digital data radio 87 and the central station 79 can be any suitable transmission scheme. The preferred application communications protocol is standard TCP/IP for connecting to the Internet. Other suitable data protocols include WAP (wireless application protocol) and VXML (voice extensible markup language). The central station 79 includes a digital data receiver 76 and a central office computer 78 and broadband Internet access 80 for connection to the Internet 82. The primary function of the central station 79 and the wireless data system 81, 83, 85 is to perform the functions of an Internet Service Provider (ISP) with respect to the portable computer 70.

Elsewhere connected to the Internet is a virtual tour-guide web site 84. The virtual tour-guide web site 84 may include a voice over IP interface 86, a natural language processor 88, an intelligent agent tour-guide 90 and a database of historical, cultural and entertainment information 92.

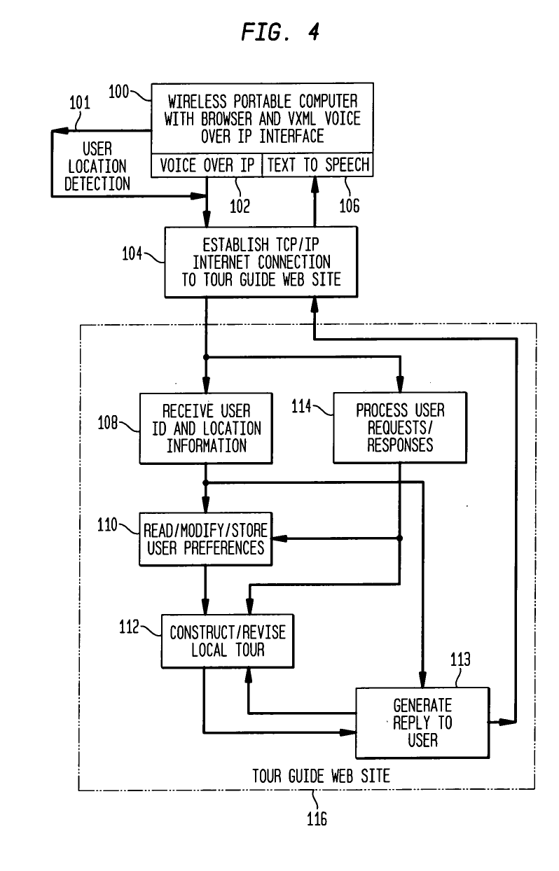

The operation of the system of FIG. 3 is illustrated in the flow chart of FIG. 4. In operation, a wireless portable computer with an Internet browser 100 establishes a connection 104 over the Internet to a virtual tour-guide web site 116 (84 in FIG. 3). In such manner, a portable computer 70 running a standard Internet browser program such as Netscape Navigator or Microsoft Internet Explorer, is able to receive tour-guide services under the present web enabled wireless virtual tour-guide system by connecting to the virtual tour-guide web site 116.

The portable computer translates 102 voice commands using voice recognition or other software, into voice over IP format, and processes received text to speech 106 as well as VXML commands into audio. Also, the portable computer reports 101 its location over the TCP/IP connection 104.

At the virtual tour-guide web site 116, the user identity and location is received 108. Standard browser cookies are used to identify previous visitors to the virtual tour-guide web site 116, without requiring a specific user identity (e.g., without an actual name). If the user has previously visited the virtual tour-guide web site 116 (determined from the cookie), the user preferences are retrieved at step 110. If the user is a first time web site user (determined by the lack of a cookie), a preferences file for the new user is established at step 110. Alternatively, the new user may prefer to register at the virtual tour-guide web site 116 and communicate the user's personal preferences.

The virtual tour-guide web site 116 receives and processes user requests and responses at step 114, which requests/responses may be by voice input or by keyboard input. In response to user requests, a local tour is constructed or selected at step 112. A series of questions, instructions and responses are generated at step 113 in connection with the generated tour at step 112. The intelligent agent (software layer 90 in FIG. 3) carries out step 112 (generation of a local tour), as well as interfaces with interpretation step 113 (in conjunction with the natural language processing layer 88 in FIG. 3). The intelligent agent may operate in English or in any other language. For each other language of interest, exhibit formats are translated into such other language, and corresponding voice recognition and text to speech software for each such language are used.

Hybrid Approaches

A key difference between the embodiments of FIGS. 1 and 3 is that FIG. 1 shows plural web sites 28, 30 to provide tour-guide services, while FIG. 3 shows one web site 84 to provide tour-guide services. In the first embodiment, the vast resources of the Internet are made available to the user. In the second embodiment the entire database of historical, cultural and entertainment information is aggregated and stored in one main virtual tour-guide web site.

A hybrid of the above two approaches provides a logical way to deploy a web enabled virtual tour-guide system, which also provides a migration path for continued growth. Beginning with a single web site provides the opportunity to establish uniform data format standards for exhibits and tours used by the intelligent agent virtual tour-guide software.

An initial database limited to the most popular exhibits and tours for a single city, for instance, is easily accommodated on a single web site. Later, additional web sites (28 in FIG. 1) for other cities or lesser-known exhibits in the same city may be added to the network by linking to such additional web sites from the main web site. Thus, in the hybrid approach, web site search portal 30 in FIG. 1 would also include the functions of virtual tour-guide web site 116 in FIG. 4 (84 in FIG. 3). In such case, the function of the intelligent agent is performed at the virtual tour-guide web site (as in FIG. 3) rather than the cellular central station (as in FIG. 1). Large server farms on the Internet store all tour information, thereby requiring little or no memory in the mobile device (70 in FIG. 3), and putting less demand on the mobile device batteries.

Linking to plural web sites (28 in FIG. 1) from the main web site (30 in FIG. 1) also permits the intelligent agent virtual tour-guide software to assemble a guided tour drawn from more than one web site information source. For example, a first web site may contain information on art museums in a city, while a second web site may contain information on famous architectural sites in that city. To construct a guided tour in that city of both Victorian art and Victorian architecture, for instance, the intelligent agent software accesses both first and second web sites to construct the requested guided tour.

Another difference between the embodiments of FIGS. 1 and 3, is that FIG. 1 shows a cellular telephone system as an intermediary adapted to receive audio and graphics content derived from the Internet and deliver the content to a telephone handset. The system of FIG. 3 shows a personal computer having direct and full digital Internet access. Providing a laptop computer with a cellular modem in FIG. 1 to replace the handset 10 creates a hybrid of the two approaches. In such case, by replacing handset 10 with a laptop and modem, the direct Internet access architecture of FIG. 3 could be used in FIG. 1.

Interactive Tour Guide

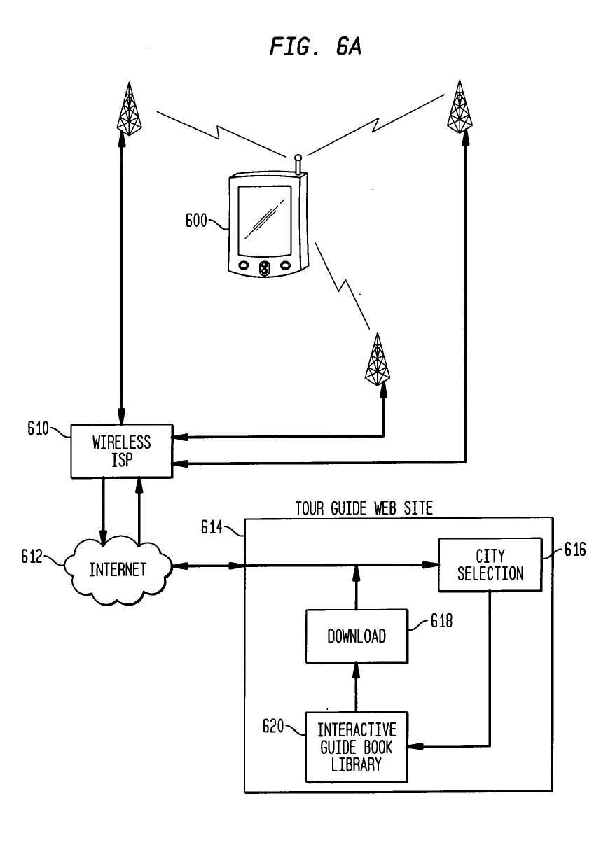

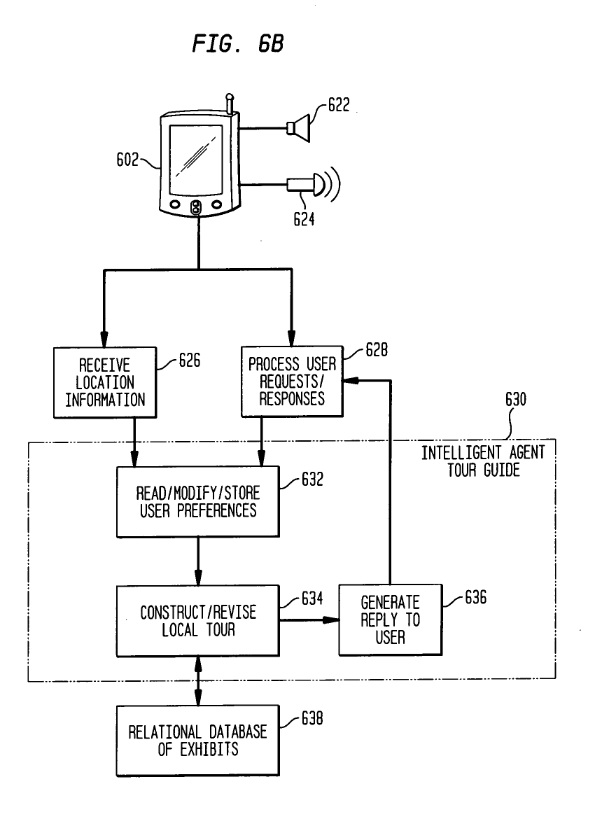

A third embodiment that does not require a continuous online connection to the Internet is shown in FIGS. 6A and 6B. In this latter embodiment, a PDA or portable tablet laptop computer 600 is preloaded with self-contained interactive tour guide software, in which the user indicates his location and/or preferences by clicking (or tapping) on a dynamic city map. While a dynamic city map on the screen of a PDA or laptop computer may be used with either of the first and second embodiments herein that are continuously connected to the Internet, a dynamic city map is particularly useful with self-contained interactive tour guide software that is not continuously connected to the Internet.

To obtain the interactive tour-guide software, a PDA or portable tablet laptop computer 600 is coupled to a tour guide web site 614 via the Internet 612 and Internet service provider (ISP) 610. A tour guide web site 614 contains a library 620 of interactive guidebooks (software forming individual interactive tour guides for each given city or location). Each interactive guidebook (interactive tour-guide) contains an intelligent agent tour guide, a respective database of exhibits and a respective dynamic city map.

To obtain an interactive tour guide for a specific city, the user connects to the tour guide web site 614 and selects a desired city 616. In response, the tour guide web site 614 downloads 618 an interactive tour guide for the selected city to the PDA or portable tablet laptop computer 600. Although the Internet service provider is shown as a wireless ISP 610, the PDA 600 may receive its interactive tour guide software and dynamic city map by any alternative connection to the Internet or even by preloading such interactive tour guide software and dynamic city map from a CD ROM or other media.

FIG. 6B is a block diagram of the operation of the interactive tour guide and dynamic city map, which is a self-contained software program within the portable PDA or tablet laptop computer 602. In addition to the touch screen, the portable PDA 602 will preferably contain a speaker 622 and a microphone 624 for interactive communication with the user by speech synthesis and speech recognition, respectively. Although the embodiment of FIG. 6 does not require a continuous online connection to the Internet, a substantial benefit is obtained by occasional connection to the Internet as may be achieved via local wireless Internet “hot spot” locations (Wi-Fi) in many cities. By occasionally connecting to the Internet, the interactive tour guide software can check the tour guide web site for updates and upgrades. In such manner, the interactive guidebook and the intelligent agent tour-guide may receive updated features and updated descriptions of exhibits as well as the addition of recently added new tour exhibits.

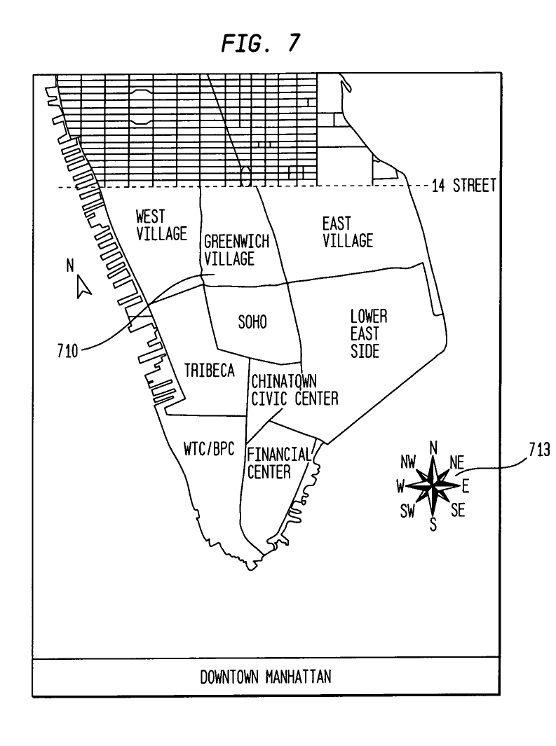

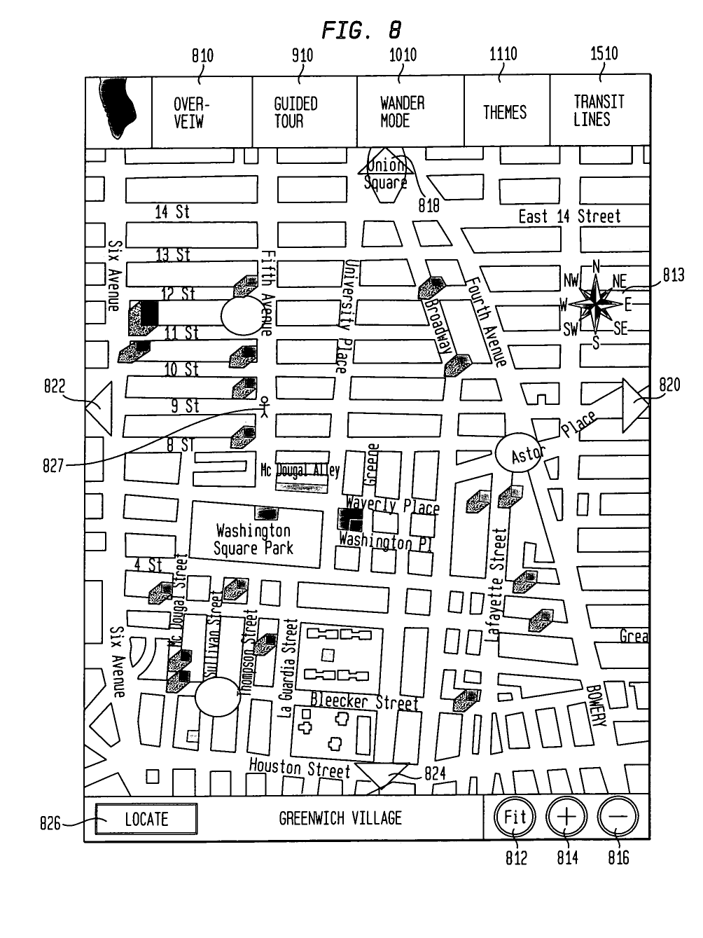

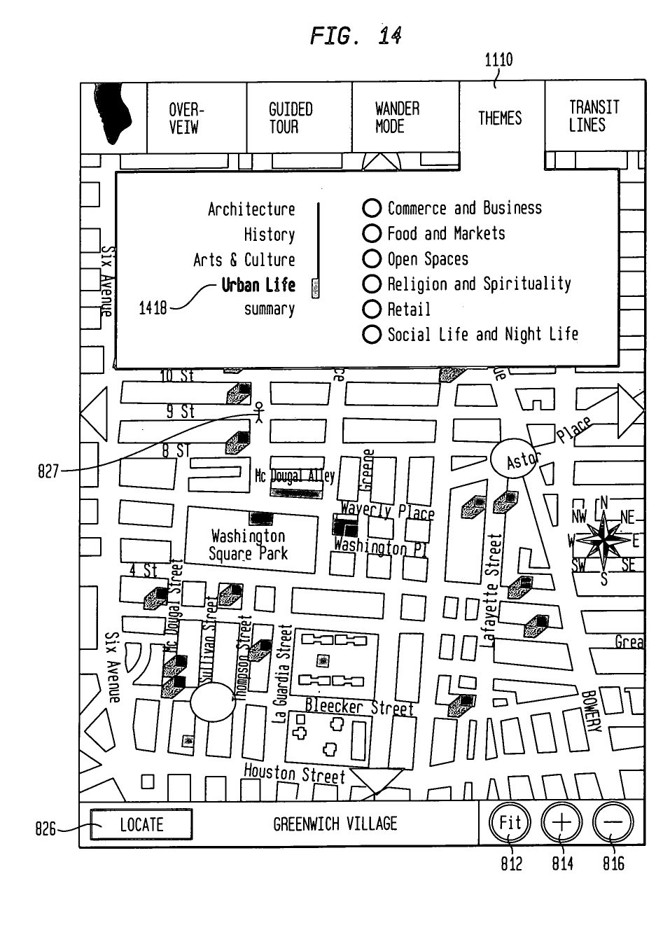

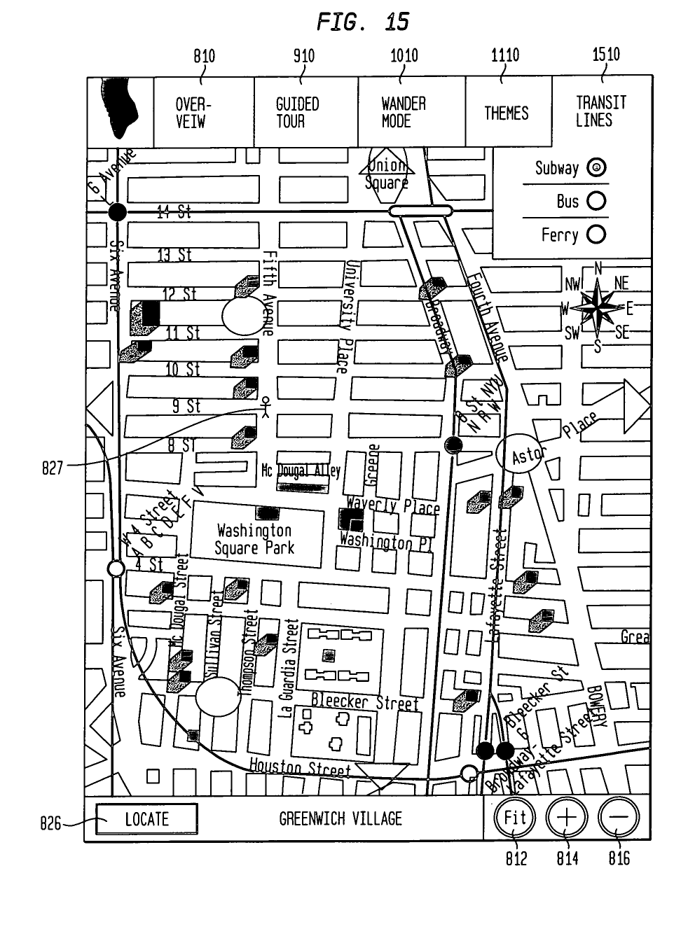

In operation, the user launches the interactive tour guide program on the PDA 602. A dynamic city map appears on the screen (FIGS. 7-15). The user may click on any exhibit illustrated on the dynamic city map to receive further information about that exhibit. However, there is a distinction between a typical interactive map and the dynamic city map of an interactive tour guide. In a typical interactive map, the user clicks on designated areas on the map (“hot spots”) to obtain further information. In an interactive tour guide as in a typical interactive map, the tourist uses the dynamic city map to obtain further information, but in addition the tourist indicates his physical location on the dynamic city map.

That is, in order to function as an interactive tour guide, the user indicates his physical location on the dynamic city map to the intelligent agent tour guide software 630 so that the interactive tour guide can provide the rich set of instructions, interactive questions, suggestions, directions and exhibit information relevant to the tour being conducted by the interactive tour guide.

The user indicates his location information 626 to the intelligent agent tour guide software 630 through one of several methods. The tourist may indicate his position on the dynamic city map by first clicking on a LOCATE button 826 and then clicking on the dynamic city map. In response to entering location information, a moveable tourist “icon” such as a small stick FIG. 827 appears on the dynamic city map to indicate the location of the tourist. For example, in FIG. 8, the stick FIG. 827 indicates that the tourist is located at the intersection of Fifth Avenue and 9th Street.

In the case where the PDA includes a GPS module, the stick FIG. 827 will be automatically placed, and will automatically move along with the movement of the tourist. Without a GPS module or other method of automatic location detection, the tourist provides the updated (new) location information. The tourist may indicate his initial and changed (new) position on the dynamic city map by moving the stick FIG. 827 (i.e. by dragging it with a pointing device). The tourist may also indicate an initial and/or updated (new) position of the stick FIG. 827 anytime by clicking on the LOCATE button 826 and then clicking on the new position on the dynamic city map.

A compass rose (713 in FIG. 7, 813 in FIG. 8) allows the tourist to orient the dynamic city map to actual physical compass points by rotating the PDA display or the PDA itself. Display rotation may be provided as a convenience feature of the interactive tour guide software. If the PDA is equipped with an internal digital compass, the dynamic city map will be automatically rotated so as to be oriented in the correct position regardless of how the tourist holds the PDA. Alternatively, the PDA may be equipped with a GPS module, by which the dynamic city map will be rotated so as to be oriented in the correct position.

Similar to the operation of the virtual tour guide web site (116 in FIG. 4), the user identity and location is received at step 626. If the user has previously used the interactive tour guide software, then the user preferences are retrieved at step 632. If the user is using the interactive tour guide for the first time, a preference file for the new user is established at step 632.

The intelligent agent tour guide 630 receives and processes user requests and responses at step 628, which requests may be by voice via microphone 624 or by clicking on designated portions of the screen of the PDA 602. In response to user requests, a local tour is constructed or selected at step 634. A series of questions, instructions and responses are generated at step 636 in connection with the tour generated at step 634.

Exhibits are stored in a relational database 638. Construction and revision of a local tour at step 634 may be implemented in using relational database technology such as standard structured query language (SQL) technology. In a relational database for example, data related to buildings may be stored as a single entity “building” data table while data relating to an architect may be stored another entity “architect” data table. Many-to-many relationships may be established by using a “building/architect” association table. In such manner, a tour consisting of all the buildings designed by single architect may be easily constructed by a simple database query.

As another example, data related to historic sites may be stored as a single entity “historic site” data table while data relating to a historical figure may be stored another entity “historical figure” data table. Again, many-to-many relationships may be established by using a “historic site/historical figure” association table. In such manner, a tour consisting of all the historic sites related to a single historical figure is easily constructed by simple database query.

As before, the user can customize the tour in progress by expressing special interests and indicating areas of interest in non-interest. The intelligent agent tour guide 630 “learns” from the requests and response of the user so that the tour guide becomes more knowledgeable with experience. For example, the intelligent agent tour guide will remember that a user in New York City had a strong interest in art museums. Later, when running another interactive tour guide for Paris, the intelligent agent tour guide software will remember such preference and suggest a tour of local art museums.

Dynamic City Map

A dynamic city map provides a graphical interface and between the user and the interactive tour guide. For example, FIG. 7 illustrates an overview of a dynamic city map of lower Manhattan.

A dynamic city map allows the entire city to fit into the limited space of the personal digital assistant. The opening screen shows an overall map of the city, with individual districts presented schematically, each shown in a different color and labeled by name. Tapping (i.e., clicking on) any of the individual districts opens a district map, in the same orientation as the overall map, and showing city blocks (in gray), streets and avenues (in white, and street/avenue labeled in black), parks and open spaces (in green, also labeled), and about thirty to forty “sites” (in blue), i.e., “exhibits” that are places of interest to a tourist.

The user indicates an area of interest by clicking on the map. Selecting the area for Greenwich Village 710 will bring up the display of FIG. 8, which shows a dynamic city map of the Greenwich Village district.

To aid in orientation, the district name appears in the lower navigation panel, (i.e. Greenwich Village) alongside “zoom in; and “zoom out; buttons 814, 816 which allow the user to survey a smaller or larger part the area. An additional button 812 labeled “Fit” reverts the “zoomed” size map to its “district” size.

Four arrow buttons on the top, bottom, left and right, corresponding to north (uptown) 818, east 820 and west 822, and south (downtown) 824, allow the user to navigate or “drag” the district map in any direction.

A neighborhood borderline indicates when a new district appears on the screen, and the district name in the lower navigation panel automatically changes accordingly if the curser moves into that district.

The dynamic city map contains various controls to provide an overview 810, a guided tour 910, a wander mode 1010, various scenes 1110 and information about transit lines 1510.

Various points of interest to tourists are indicated as “hot spots” (dynamic links or hyper links) on the dynamic city map. The clicking or tapping on any of the dynamic links will bring up information box about the exhibit. In addition to a textual description of the exhibit and its history, the information box may contain a photograph of each exhibit as it exists in the present day, as well as a photograph of the exhibit as it existed in the past. The past and present photographs may blend into each other in the manner of time-lapse photography, either going forward or backwards in time.

Hyperlinked City Descriptions

Unlike a printed guidebook, the exhibit descriptions in an interactive tour-guide are cross-linked (hyperlinked) to each another in a dynamic, interactive manner. Each district is described (by text, voice or video) through three or four related screens or panels. One screen provides an overall introduction to the district while the other screens describe notable aspects of the district's history, character, famous personalities, as well as many local services.

The texts of both the district overviews and the local exhibits contain certain terms, names, and phrases that are highlighted in blue; these are hyperlinked to other “screens”. Further desired information can be “drilled down” by clicking on successive hyperlinks. Finally, a hyperlinked alphabetical index to all proper names of places, buildings, events, etc. allows users to search the interactive tour-guide for any specific and pertinent City information. The interactive tour-guide is the first handheld mobile wireless City encyclopedia.

GUIDED TOUR

The interactive tour-guide software offers pre-arranged (canned) tours through city districts. By tapping the “guided tour” button 910 at the upper navigation panel, one or more tour routes appear on the screen, each designated by a different color and letter. Tapping the “start” or “end” point of any of these tours brings up a panel describing that particular route, along with a prompt to the first exhibit on the tour. The text entry for the selected “site” concludes with instructions to the next exhibit, and so on.

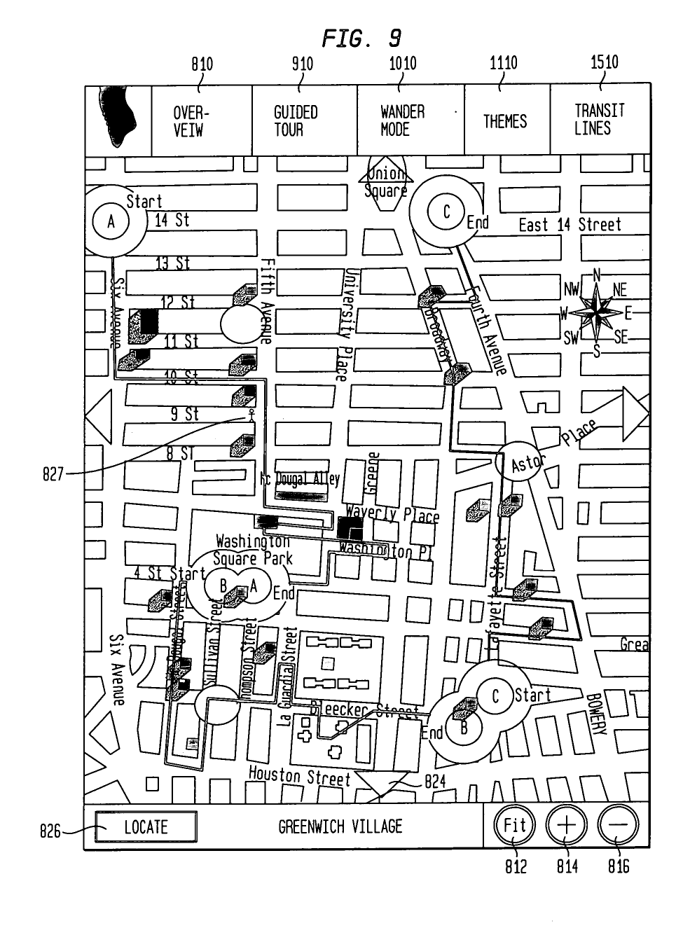

In operation, clicking on the guided tour button 910 will bring up the display of FIG. 9, which displays a variety of suggested tours. In particular, tour A, tour B and tour C are illustrated. Tour A ends where tour B begins and tour C starts where tour B ends. When the tourist enters his location information, a customized tour can be reconfigured so that the starting point is nearest the tourist.

To begin a tour, the user indicates his location as being at a given first exhibit. The interactive tour guide then delivers either spoken, textual, graphic and/or video information about the first exhibit. The user may ask for more information (by spoken word or by data entry) about the present exhibit or indicate that he wants the tour to continue on to the next exhibit. If so, the interactive tour guide will give travel directions (again, by speech, text, graphics and/or video), explaining to the user how to go to the next exhibit on the tour. Video may include a talking avatar. After the user indicates (again, by spoken word or by clicking on the screen) that he has arrived (is located) at the new exhibit, the interactive tour guide will provide information about the new exhibit. A silent mode of output (i.e. text or images only) may be preferred in a quiet environment, unless headphones are available. A silent mode of input (i.e. data entry) may be preferred in a quiet environment where speech would disturb others.

If the user has not indicated any preferences, tours A, B and C will be canned tours. However, if the user has previously indicated preferences, the suggested tours will reflect those preferences. For example, if the tourist has indicated “no interest” in art museums, then the suggested tours will skip over art museums. A large variety of intelligent agent tour-guide responses (630 in FIG. 6B) may be modeled from the universe of the typical and likely behavior of an actual human tour-guide. The interactive guidebook of the present invention is more akin to a human tour guide as compared to a printed guidebook.

Continuing the above example, should the user indicate an interest by tapping on a specific art museum outside of the tour route, the intelligent agent tour guide might be programmed to ask, “Would you like to see this art museum?” If the answer was yes, directions are provided thus departing from the originally configured tour. Then, after departure from the art museum, the intelligent agent tour guide might be programmed to ask, “Would you like to see other art museums?” In such manner, the intelligent agent tour guide modifies the preferences of the tourist by learning what the tourist likes and dislikes.

Wander Mode

The interactive tour-guide system of the present invention offers users an opportunity to “wander” throughout the city, going “off” the selected tour route, selecting their own routes as they move through a district. At the lower left corner of most descriptive text “panels,” there is a yellow icon [“w”], which, when tapped (selected) by the user, indicates adjacent “sites” of interest by flickering blue “site” buttons.

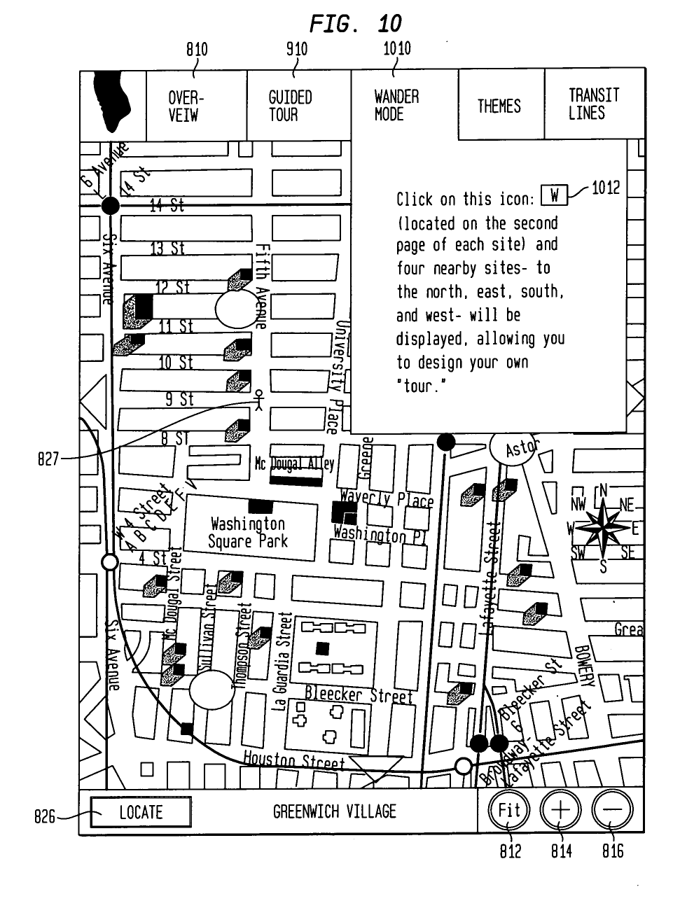

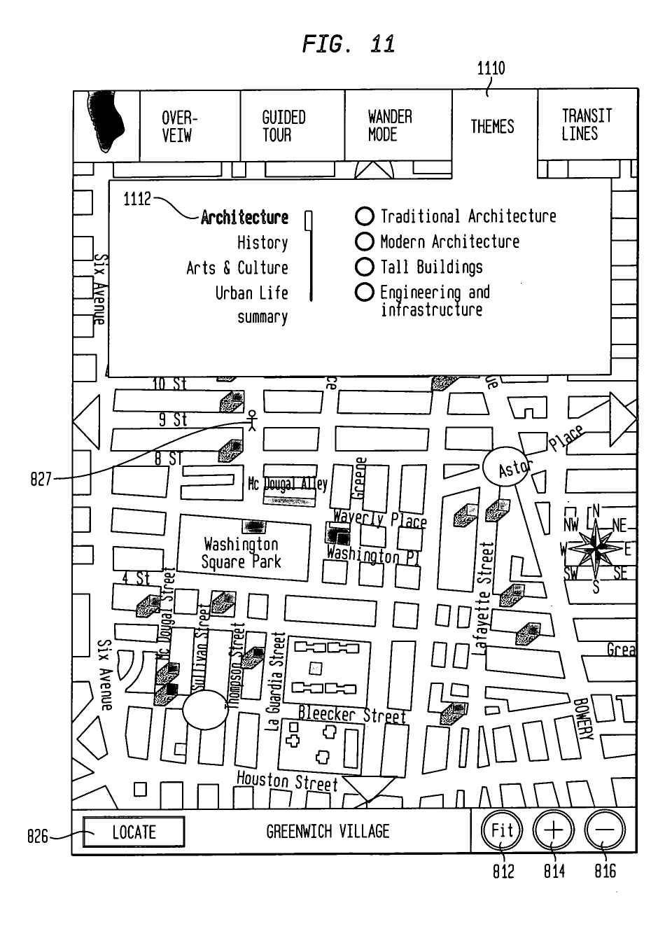

Clicking on the wander mode button 1010 will bring up the display of FIG. 10. Wander mode gives the user the option of choosing the next exhibit from a selection of neighboring exhibits. Starting at any given exhibit, the user may enter wander mode by clicking on the “w” icon. In wander mode, a selection of neighboring exhibits flashes on and off. The user selects the next exhibit in the tour from the available selection of (flashing) neighboring exhibits to the north, east, south or west, allowing users to select the one that is most appealing, and/or is located in the general direction in which they want to move.

The interactive tour guide then provides directions to the next exhibit. Upon arrival (when the tourist provides new location information), the interactive tour guide provides information about the selected exhibit. So long as the interactive tour guide remains in wander mode, a new selection of neighboring exhibits relative to the current exhibit, will flash on and off.

Themes

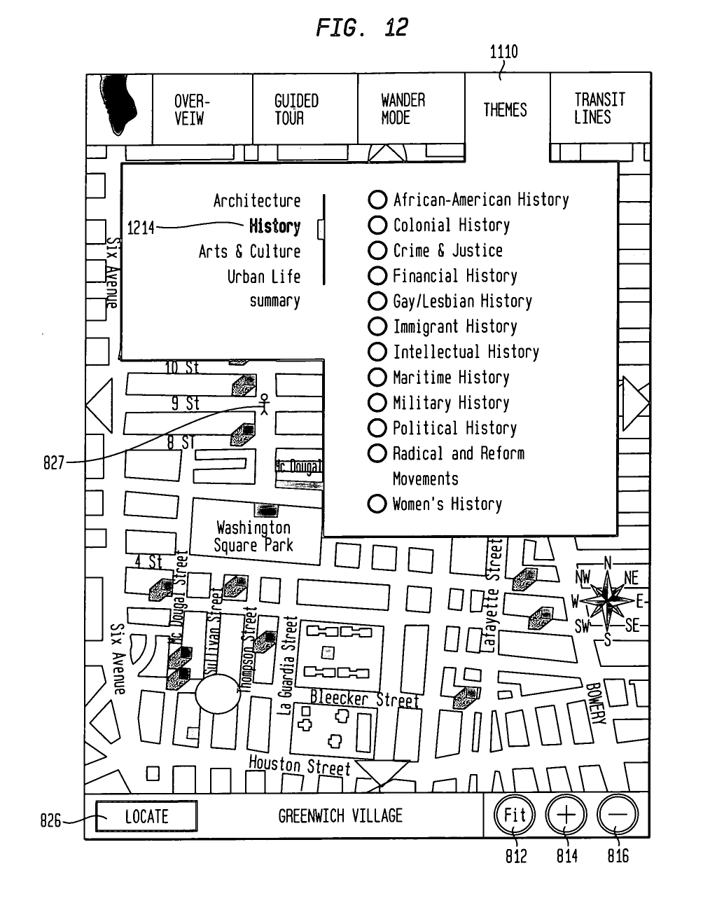

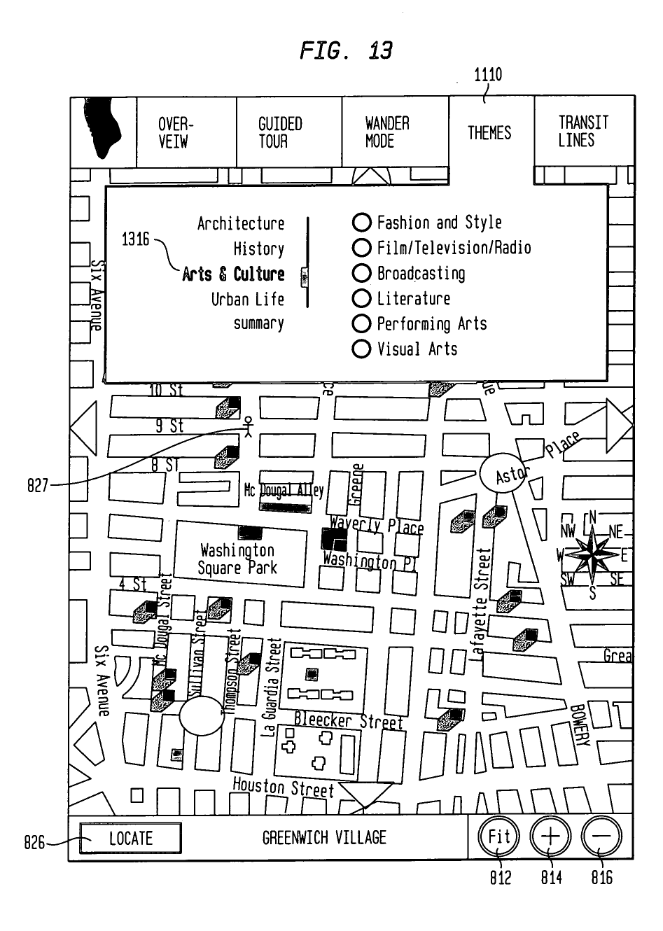

A specialized variety of prearranged (i.e. canned) guided tours are themed tours. Clicking on the themes button 1110 will bring up the display of FIG. 11. In particular, a guided tour of architecture 1112 may be designed around the themes of either traditional architecture, modem architecture, tall buildings or engineering and infrastructure. As shown in FIG. 12 various guided tours of history 1214 may be designed around the themes of either African-American history, colonial history, crime & justice, financial history, gay/lesbian history, immigrant history, intellectual history, maritime history, military history, political history, radical and reform movements, and women's history. In a similar vein, various guided tours of arts and culture 1316 may be designed around the themes of fashion and style, film/television/radio, broadcasting, literature, performing arts and visual arts. Similarly, various guided tours of urban life may be designed around themes of either commerce and business, food and markets, open spaces, religion and spirituality, retail, social life and night life.

Historical (Archival) Photographs of Exhibits

A special visual feature of interactive tour guide software, which takes advantage of its multi-media capability, is a matched pair of images that may accompany the selection of each exhibit. The matched pair of images are a current photograph and a custom-created current (contemporary) photograph (or sketch) that precisely recreates a historic archival photograph of the exhibit from the same point of view.

The initial view of each selected exhibit opens with the contemporary photograph, which then, in a second or two, automatically dissolves into the archival view of the exhibit as it was in the past. A pair of control buttons below the image, which are labeled with the respective dates corresponding to the past and present images, allow the user to switch back and forth between the contemporary image and the archival image.

Overlaid Information

To facilitate traveling between exhibits, the dynamic city map includes overlays of available transit lines 1510. As shown in FIG. 15, transit lines (subway, bus and ferry lines) may be individually overlapped onto the dynamic city map to show the relationship of various transit lines to the exhibits. Other types of overlaid information may include restaurants, rest stops, hotels, shops, movie houses and the like. The interactive tour guide software of the present invention, being made aware of the location of the tourist, is able to provide directions from the tourist's location to such transit line stations, restaurants, rest stops, hotels, shops, movie houses as well as indicate the nearest of such destinations to the tourist.

Revenue Models

Revenue to support the interactive tour-guide system may be derived by levying tour fees, subscriber fees, advertising fees or licensing fees. The present system includes features that permit any revenue model or a combination of revenue models to be used. In the tour fee model, a fee may be charged to a credit card before the interactive tour-guide is downloaded. In the case of a wireless web enabled embodiment, a fee may be charged to a credit card before the guided tour is delivered. The fee may be either a flat fee per tour, a fee proportional to the length of the tour or the amount of data delivered during the tour. Charging by the amount of data delivered permits revenue sharing among various owners of copyrighted tour materials used in the tour.

Advertising may be included in the tour via the intelligent agent software. Users are given a list of nearby restaurants when the user asks, for example, “Where can we eat?” or says, “We're hungry.” The intelligent agent can suggest a restaurant stop at certain points in a tour, for example. Other types of businesses of interest to users include lodging, travel and car rental agencies, clothing stores, movies, theatres, sporting events, souvenir shops, beauty parlors, drug stores, gift shops and the like. In each case, the intelligent agent is responsive to key words in a user's inquiry to look up in its advertiser database the closest business or businesses, which correspond to the user inquiry. The known geographic location of the user is taken into account in selecting the closest recommendations. Advertising revenue may be based on subscription, i.e., the amount of time a business is listed in the database such as a predetermined cost per month. In the alternative, advertising revenue may be based on the number of times a referral to such business is provided to the user, i.e., at a predetermined cost per play.

1. A system method for providing a guided tour for a user, said method comprising:
requesting said guided tour;
determining a first location from said user, said first location representing the general locale of said guided tour;
selecting said guided tour based on said first location, said guided tour containing a plurality of exhibits in the vicinity of said first location;
providing directions to said user to enable said user to travel to a given exhibit of said plurality of exhibits;
determining a second location of said user to provide a detected user location; and
providing a description of said given exhibit to said user when said detected user location indicates that said user is near said given exhibit.

2. A system method in accordance with claim 1, wherein said step of selecting a guided tour based on said first location comprises:
selecting a plurality of exhibits from an inventory of exhibits in the vicinity of said first location to form a selected plurality of exhibits; and
listing said selected plurality of exhibits in an ordered list to form said guided tour containing said selected plurality of exhibits.

3. A system method in accordance with claim 1, wherein said step of selecting a guided tour based on said first location comprises:
selecting a predetermined tour from an inventory of predetermined tours related to said first location and based on a preference of said user, each of said predetermined tours comprising an ordered list of a respective plurality of exhibits.

4. A system method in accordance with claim 1, wherein said step of selecting a guided tour based on said first location comprises:
selecting a predetermined tour from an inventory of predetermined tours related to said first location, each of said predetermined tours comprising an ordered list of a respective plurality of exhibits; and
modifying said predetermined tour based on a preference of said user.

5. A system method in accordance with claim 4, wherein said step of modifying said predetermined tour based on a preference of said user comprises deleting an exhibit from said predetermined tour.

6. A system method in accordance with claim 4, wherein said step of modifying said predetermined tour based on a preference of said user comprises adding an exhibit to said predetermined tour.

7. A system method in accordance with claim 1, wherein said step of determining a second location of said user to provide a detected user location comprises using a Global Positioning Satellite receiver.

8. A system method in accordance with claim 1, wherein said step of determining a second location of said user to provide a detected user location comprises using signal triangulation of a signal from said user location received at a plurality of receiving antennas.

9. A system method in accordance with claim 1, wherein said step of determining a second location of said user to provide a detected user location comprises said user providing an indication of the location of said user.

10. A system method in accordance with claim 2, wherein said ordered list of said selected plurality of exhibits is in the order of the shortest tour containing said selected plurality of exhibits.

11. A system method in accordance with claim 2, wherein said ordered list of said selected plurality of exhibits is in the order of the priority preferred by said user containing said selected plurality of exhibits.

12. A system method in accordance with claim 10, wherein said given exhibit is the nearest exhibit to said user on said guided tour.

13. A system method in accordance with claim 1, wherein said request for a guided tour is an oral request.

14. A system method in accordance with claim 1, wherein said description of said given exhibit to said user is an aural description of said given exhibit.

15. A system method in accordance with claim 1, wherein said directions to said user to enable said user to travel to said given exhibit of said plurality of exhibits are aural directions.

16. A system method in accordance with claim 1, wherein said description of said given exhibit to said user is received over a wireless communication link.

17. A system method in accordance with claim 1, wherein said user makes requests related to said guided tour over a wireless communication link.

18. A system method using an interactive map for providing a guided tour for a user, said method comprising:
requesting said guided tour;
determining a first location on said interactive map, said first location representing the location of said user;
selecting said guided tour based on said first location, said guided tour containing a plurality of exhibits in the vicinity of said first location;
providing directions to said user to enable said user to travel to a given exhibit of said plurality of exhibits;
determining a second location on said interactive map, said second location representing a new location of said user; and
providing a description of said given exhibit when said new location indicates that said user is near said given exhibit.

19. A system method in accordance with claim 18, wherein said step of selecting a guided tour based on said first location comprises:
selecting a plurality of exhibits from an inventory of exhibits in the vicinity of said first location to form a selected plurality of exhibits; and
listing said selected plurality of exhibits in an ordered list to form said guided tour containing said selected plurality of exhibits.

20. A system method in accordance with claim 18, wherein said step of selecting a guided tour based on said first location comprises:
selecting a predetermined tour from an inventory of predetermined tours related to said first location and based on a preference of said user, each of said predetermined tours comprising an ordered list of a respective plurality of exhibits.

21. A system method in accordance with claim 18, wherein said step of selecting a guided tour based on said first location comprises:
selecting a predetermined tour from an inventory of predetermined tours related to said first location, each of said predetermined tours comprising an ordered list of a respective plurality of exhibits; and
modifying said predetermined tour based on a preference of said user.

22. A system method in accordance with claim 21, wherein said step of modifying said predetermined tour based on a preference of said user comprises deleting an exhibit from said predetermined tour.

23. A system method in accordance with claim 21, wherein said step of modifying said predetermined tour based on a preference of said user comprises adding an exhibit to said predetermined tour.

24. A system method in accordance with claim 18, wherein said step of determining said new location of said user comprises using a Global Positioning Satellite receiver.

25. A system method in accordance with claim 18, wherein said step of determining said new location of said user comprises using signal triangulation of a signal from said user location received at a plurality of receiving antennas.

26. A system method in accordance with claim 18, wherein said step of determining said new location of said user comprises said user providing an indication of the location of said user on said interactive map.

27. A system method in accordance with claim 19, wherein said ordered list of said selected plurality of exhibits is in the order of the shortest tour containing said selected plurality of exhibits.

28. A system method in accordance with claim 19, wherein said ordered list of said selected plurality of exhibits is in the order of the priority preferred by said user containing said selected plurality of exhibits.

29. A system method in accordance with claim 27, wherein said given exhibit is the nearest exhibit to said user on said guided tour.

30. A system method in accordance with claim 18, wherein said request for a guided tour is an oral request.

31. A system method in accordance with claim 18, wherein said description of said given exhibit to said user is an aural description of said given exhibit.

32. A system method in accordance with claim 18, wherein said directions to said user to enable said user to travel to said given exhibit of said plurality of exhibits are aural directions.

33. A system method in accordance with claim 18, wherein an updated description of said given exhibit to said user is received over a wireless communication link.
